(19) United States
(12) Patent Application Publication
(10) Pub. No.: US 2020/0346379 A1
(43) Pub. Date: Nov. 5, 2020

(54) FISHING LURE AND APPARATUS AND METHOD OF MAKING THE SAME

(71) Applicants: Daniel Orefice, Somers, CT (US); Michael Orefice, Milford, CT (US)

(72) Inventors: Daniel Orefice, Somers, CT (US); Michael Orefice, Milford, CT (US)

(21) Appl. No.: 16/856,699

(22) Filed: Apr. 23, 2020

Related U.S. Application Data
(60) Provisional application No. 62/841,005, filed on Apr. 30, 2019.

(51) Int. Cl. B29C 45/14; A01K 85/10; B29C 45/26; B29C 45/00

(52) U.S. Cl. CPC B29C 45/14549; A01K 85/10; B29K 2101/12; B29C 45/0053; B29C 45/26

(57) ABSTRACT

A fishing lure and apparatus and method of making the same. A fishing lure according to aspects of the invention include a lure body formed about a through wire. Eye loops are provided at opposed ends of the trough wire to attach a tackle element for catching a game fish. An optional decorative layer is applied to the lure body to mimic the visual appearance of a bait. A clear protective shell is molded about the lure body to encapsulate the lure body and protect the lure body, and optional decorative layer from damage. The apparatus includes a first and second mold, with the first mold forming the lure body in the shape of the bait and the second mold forming the clear protective shell about the lure body.

### CROSS-REFERENCE TO RELATED APPLICATION

This application claims the benefit of priority of U.S. provisional application No. 62/841,005 filed Apr. 30, 2019, the contents of which are herein incorporated by reference.

### BACKGROUND OF THE INVENTION

The present invention relates to fishing lures and, more particularly, to lure bodies and apparatus and methods of making the same.

The problem with conventional fishing lures that are easily damaged. A damaged fishing lure can include both a fishing lure that is extremely damaged and cannot be used or a slightly damaged fishing lure where the performance or appearance may be altered in such a way that it does not perform as well as it should in attracting game fish. Either way, a damaged fishing lure does not perform as well as it was originally intended to perform.

Other fishing lure bodies within this field are typically made with an epoxy or a resin material as a clear protective layer. This clear protective layer may be sprayed, brushed, or dipped onto the lure body. The problem with this type of clear protective layer is that it is easily damaged and cracked which alters the appearance and the performance of the fishing lure. Damage may be imparted to the lure during storage and handling or it may occur while fishing when it may strike rocks, stumps, and other hazards within the fishing habitat.

As can be seen, there is a need for an improved fishing lure body as well as apparatus and methods for making the same to increase durability and consistency from one batch to another.

### SUMMARY OF THE INVENTION

In one aspect of the present invention, a method of forming a fishing lure is disclosed. The method includes providing a first mold having an internal cavity dimensioned to mimic a shape of a bait. The first mold having a 15 extending from a face of the first mold around a periphery of the interior cavity. An eye loop of a through wire is placed on the post so that the through wire is suspended within the interior cavity. A lure body is then formed about the through wire. A second mold is provided. The second mold has a cavity dimensioned to surround the lure body in a spaced apart relation so that a protective shell composition can encapsulate the lure body. The second mold has a suspension post protruding from a face of the second mold outside the cavity. The lure body is suspended in the cavity by the suspension post. A clear protective shell is formed within the cavity to encapsulate the lure body.

In some embodiments, a decorative layer is applied to the lure body. The decorative layer carries visual indicia to mimic the bait.

The method may also include joining a first half of the first mold with a second half of the first mold. The second half of the first mold has a corresponding internal cavity corresponding to the interior cavity. The corresponding internal cavity may be a mirror image of the internal cavity.

In other embodiments, the method includes injecting the protective shell composition through a channel extending between an exterior of the second mold and the cavity.

In other aspects of the invention, a system for forming a fishing lure is disclosed. The system includes a first mold having an interior cavity dimensioned to mimic a bait. A post protrudes from a face of the first mold outside a periphery of the interior cavity. The post is configured to suspend an eye loop of a through wire in the interior cavity about which a lure body is formed within the interior cavity. A second mold has a cavity dimensioned to surround the lure body in a spaced apart relation between the lure body and a sidewall of the cavity so that a protective shell composition can encapsulate the lure body. A suspension post protrudes from a face of the second mold. The suspension post is configured to retain the eye loop of the through wire to suspend the lure body within the cavity in the spaced apart relation.

In some embodiments, a channel is configured to communicate a composition for forming the lure body from an exterior of the first mold to the interior cavity. An injection channel is also configured to communicate a protective shell composition from an exterior of the second mold to the cavity.

In some embodiments, the protective shell composition is a thermoplastic selected from the group consisting of acrylic, acrylonitrile butadiene styrene, nylon, polycarbonate, and polyvinyl chloride.

In other aspects of the invention, a fishing lure is disclosed. The fishing lure includes a through wire having an eye loop formed at a first end and a second end of the through wire. A lure body is formed around the through wire with the lure body having a shape to mimic a bait. A clear protective layer is molded about the lure body to encapsulate lure body, wherein the clear protective layer is formed of a thermoplastic selected from the group consisting of acrylic, acrylonitrile butadiene, styrene, nylon, polycarbonate, and polyvinyl chloride.

In other embodiments, a decorative layer is applied to a surface of the lure body. The decorative layer carries visual indicia to mimic a visual appearance of the bait.

In yet other embodiments, a tackle element is attached the eye loop. The tackle element is one or more of a snap-link, a swivel, a spinner, and a hook.

These and other features, aspects and advantages of the present invention will become better understood with reference to the following drawings, description and claims.

### BRIEF DESCRIPTION OF THE DRAWINGS

FIG. 1 is a top plan view of 18a first mold with the eyelets of a through wire applied to the post;

FIG. 2 is a top plan view of the first mold applying a lure body to the through wire;

FIG. 3 is a top plan view of the second mold with the eyelets of the through wire suspending the lure body in a cavity of the second mold;

FIG. 4 is a top plan view of the second mold with a clear protective layer injection molding around the lure body;

FIG. 5 is a side elevation view of the fishing lure;

FIG. 6 is a partial sagittal sectional view showing the clear protective cover around the lure body; and

FIG. 7 is a partial dorsal sectional view showing the protective layer around the lure body.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved fishing lure body, with apparatus and methods of forming the lure body. The improved fishing lure body includes a clear protective shell to encase the decorative fish attracting properties carried on an underlying lure body. The clear protective shell is formed about the lure body utilizing injection molding technology that improves consistency during the manufacturing process. The clear protective shell increases durability of the finished lure body with the thermoplastic polymers used in this process. The end-product, fishing lures in this scenario, will be more durable, and have consistent performance and appearance between different batches and different manufacturing lots.

Aspects of the present invention adds a clear protective shell to the outside of the fishing lure body that improves appearance and performance. This added clear protective shellr extends the life of the product and also improves consistency in the manufacturing process.

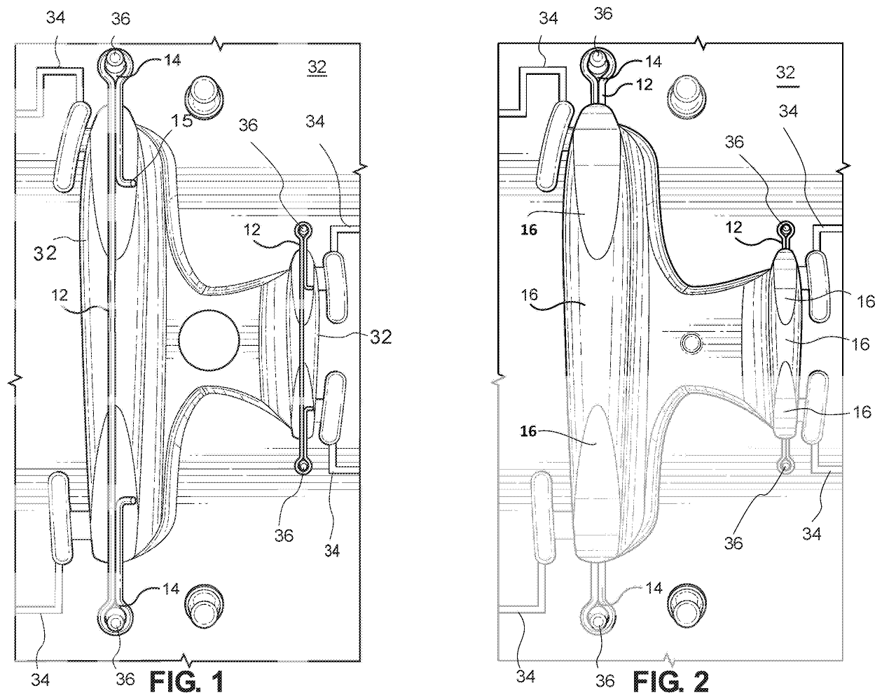

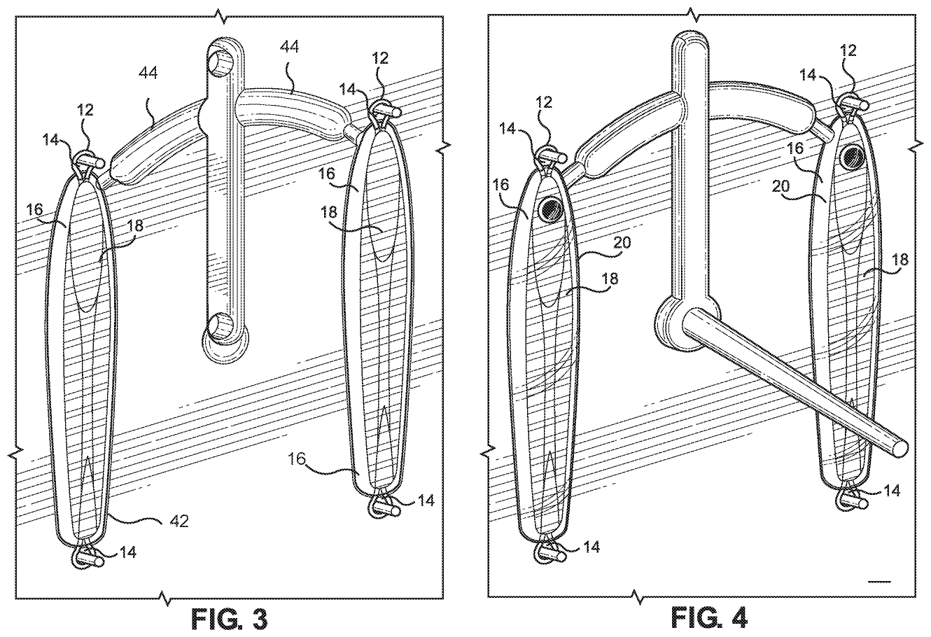

As seen in reference to FIG. 1, a first mold 30 for forming an inner lure body 16 is shown. The first mold 30 has an interior cavity 32 dimensioned to the shape of the inner lure body 16. A plurality of inlet channels 34 are in fluid communication with the interior cavity 32 and an exterior of the first mold 30. The inlet channel 34 communicates a composition for forming the inner lure body 16 within the interior cavity 32. As will be appreciated, the mold 30 may include a plurality of inner cavities 32, channels 34, and associated posts 36 to form a plurality of lure bodies 16 in a single casting or molding process. The first mold 30 may also carry inner cavities 32 to form lure bodies 16 of different sizes and different shapes. The first mold 30 will have a corresponding second half which may be a mirror image of the first half to form a symmetrical lure body 16 or may have a dissimilar second half to form an asymmetrical lure body 16.

The post 36 is configured to suspend a through wire 12 within the interior cavity 32. The through wire 12 has an eye loop 14 disposed at opposed ends of the through wire 12. The eye loop 14 is provided to attach a tackle item, such as hooks, spinners, eyelets, snap links, or a fishing line to the lure 10. In the non-limiting embodiment shown, the post 36 is disposed at opposed ends of the interior cavity 32. As will be appreciated from the present disclosure, the through wire 12 may extend through a longitudinal length of the interior cavity 32, for attachment of the tackle item to a head and a tail end of the lure 10. The through wire 12 may also be suspended between one or more of a dorsal or a ventral surface of the lure body 16 for suspension of tackle items to the dorsal or ventral aspects of the lure 10. When desired, the through wire 12 may also be formed with an alignment arm 15 that becomes embedded in the inner lure body 16 and maintains an alignment of the eye loop 14 in a desired orientation relative to the lure body 16.

As seen in reference to FIG. 2, the first mold 30 is closed with its corresponding second half and the composition material of the lure body 16 is formed within the interior cavity 32 around the through wire 12. The composition may include a suitable material, depending upon the desired characteristics for the lure 10. By way of non-limiting example, for a weighted lure, materials such as lead, tungsten, tin, zinc, bismuth, etc. may be utilized. For a non-weighted lure, the composition may include plastics. The composition is melted, then cast or injected into the mold 30 to form the lure body 16 around the through-wire 12.

Once the lure body 16 has been formed and has sufficiently cured or cooled, the lure body 16 is removed from the first mold 30. A decorative layer 18 may then be applied to the lure body 16. The decorative layer 18 may be applied as one or more of a painted finish, a foil wrap. The decorative layer 18 provides a visual attractant for encouraging game fish to take the lure. The decorative layer 18 may have visual properties to simulate a bait, such as a bait fish, a crustacean, a mollusk, a reptile, a worm, an aquatic mammal, and the like.

Once the decorative layer 18 has been applied to the lure body 16, the lure body is inserted into a second mold 40. The second mold 40 includes a cavity 42 for forming the outer protective shell 20 around the lure body 16. The second mold 40 also includes an injection channel 44 to communicate a protective shell composition from the exterior of the second mold 40 to the cavity 42. The second mold 401 also has a post 46 disposed at opposed ends of the cavity 42. The post 46 is configured to be received in the eye loops 14 of the through wire 12 to suspend the lure body 16 within the cavity 42.

In preferred embodiments, the cavity 42 is dimensioned to surround the lure body 16 in a spaced apart relation so that the protective shell composition can encapsulate the lure body 16 as an outer clear protective shell 20. The clear protective shell composition may include thermoplastic materials selected from the group consisting of acrylic, acrylonitrile butadiene styrene, nylon, polycarbonate, polyvinyl chloride, etc. The clear protective shell 20 may be transparent or translucent and may include a color tint to complement or enhance the visual appearance of the decorative layer 18 to attract a desired game fish.

Once the clear protective shell 20 has cured, the lure 10 may be removed from the second mold 40. The lure 10 may then be processed for final preparation by the attachment of the desired tackle items to one or more of the wire loops 14 of the through wire 12 disposed at the ends of the lure 10.

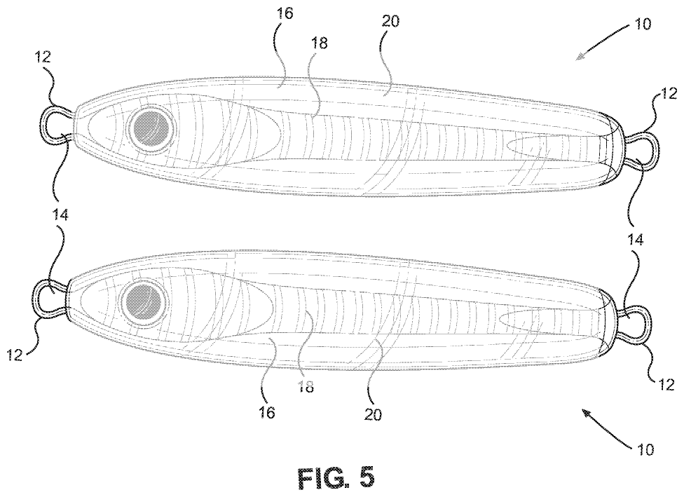

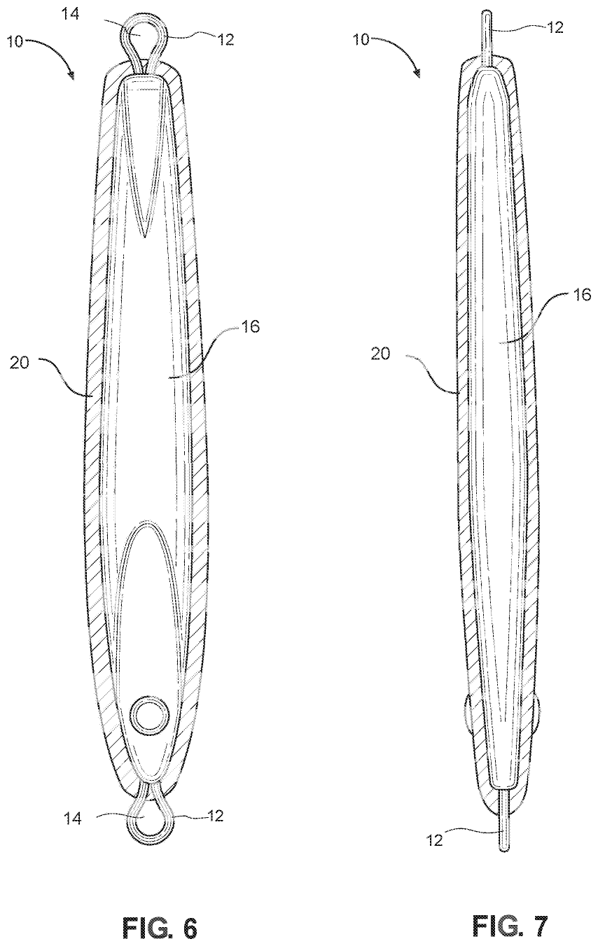

Having described the method and apparatus for forming a lure 10, a non-limiting embodiment of a lure 10 according to aspects of the invention is described in reference to FIG. 5. The lure 10 includes an inner lure body 16 shaped to a desired bait dimension. A through wire 12 extends through the lure body 16, the through wire 12 having an of eye loop 14 at an end of the through wire 12. A decorative layer 18 is carried on the lure body 16. As previously indicated, the decorative layer 18 has visual indicia to resemble or mimic a desired bait. In some embodiments, the lure body 16 may include a weighted front end and a weighted tail end by incorporation of a weighted material in the lure body 16 to improve the action of the lure 10. A clear protective outer layer 10 encapsulates the lure body 16 and decorative layer 18, with the eye loops 14 extending from an outer surface of the clear protective layer 10.

It should be understood, of course, that the foregoing relates to exemplary embodiments of the invention and that modifications may be made without departing from the spirit and scope of the invention as set forth in the following claims.

What is claimed is:

1. A method of forming a fishing lure, comprising:
providing a first mold, the first mold having an internal cavity dimensioned to mimic a shape of a bait, the first mold having a post extending from a face of the first mold around a periphery of the interior cavity;
placing an eye loop of a through wire on the post so that the through wire is suspended within the interior cavity;
forming a lure body about the through wire;
providing a second mold, the second mold having a cavity dimensioned to surround the lure body in a spaced apart relation so that a protective shell composition can encapsulate the lure body, the second mold having a suspension post protruding from a face of the second mold outside the cavity;
suspending the lure body in the cavity on the suspension post; and
forming a protective shell within the cavity to encapsulate the lure body.

2. The method of claim 1, further comprising:
applying a decorative layer to the lure body.

3. The method of claim 2, wherein the decorative layer carries visual indicia to mimic the bait.

4. The method of claim 1, further comprising:
joining a first half of the first mold with a second half of the first mold, the second half of the first mold having a corresponding internal cavity corresponding to the interior cavity.

5. The method of claim 4, wherein the corresponding internal cavity is a mirror image of the internal cavity.

6. The method of claim 1, further comprising:
injecting the protective shell composition through a channel extending between an exterior of the second mold and the cavity.

7. A system for forming a fishing lure, comprising:
a first mold having an interior cavity dimensioned to mimic a bait, a post protruding from a face of the first mold outside a periphery of the interior cavity, the post configured to suspend an eye loop a through wire in the interior cavity about which a lure body is formed within the interior cavity; and
a second mold having a cavity dimensioned to surround the lure body in a spaced apart relation between the lure body and a sidewall of the cavity so that a protective shell composition can encapsulate the lure body, a suspension post protruding from a face of the cavity, the suspension post configured to retain the eye loop to suspend the lure body within the cavity in the spaced apart relation.

8. The system of claim 7, the first mold further comprising:
a channel configured to communicate a composition for forming the lure body from an exterior of the first mold to the interior cavity.

9. The system of claim 7, the second mold further comprising:
an injection channel configured to communicate a protective shell composition from an exterior of the second mold to the cavity.

10. The system of claim 9, wherein the protective shell composition is a thermoplastic selected from the group consisting of acrylic, acrylonitrile butadiene styrene, nylon, polycarbonate, and polyvinyl chloride.

11. A fishing lure, comprising:
a through wire having an eye loop formed at a first end and a second end of the through wire;
a lure body formed around the through wire, the lure body having a shape to mimic a bait; and
a clear protective layer molded about the lure body to encapsulate lure body, wherein the clear protective layer is formed of a thermoplastic selected from the group consisting of acrylic, acrylonitrile butadiene, styrene, nylon, polycarbonate, and polyvinyl chloride.

12. The fishing lure of claim 11, further comprising:
a decorative layer applied to a surface of the lure body, the decorative layer carrying visual indicia to mimic a visual appearance of the bait.

13. The fishing lure of claim 11, further comprising:
a tackle element attached the eye loop.

14. The fishing lure of claim 13, wherein the tackle element is one or more of a snap-link, a swivel, a spinner, and a hook.
